(19) United States
(12) Patent Application Publication
(10) Pub. No.: US 2006/0003257 A1
(43) Pub. Date: Jan. 5, 2006

(54) Dye composition of the optical recording medium

(75) Inventors: Ming-Chia Li, Taichung (TW); Chien-Liang Huang, Tao-Yuan City (TW); Wen-Yih Liao, Taichung City (TW); Tzuan-Ren Jeng, Hsin-Chu City (TW); Ching-Yu Hsieh, Hsin-Chu (TW); An-Tse Lee, Taipei (TW)

Correspondence Address: GENUS LAW GROUP, 315 MOOREFIELD ROAD SW, VIENNA, VA, 22180, US

(73) Assignee: INDUSTRIAL TECHNOLOGY RESEARCH INSTITUTE

(21) Appl. No.: 10/983,121

(22) Filed: Nov. 8, 2004

(30) Foreign Application Priority Data
Jun. 30, 2004 (TW) 093119677

(51) Int. Cl. G11B 7/26

(52) U.S. Cl. 430/270.13; 430/270.18; 428/64.8; 369/288; 430/945

(57) ABSTRACT

The present invention provides a dye composition suitable for forming an information recording layer for carrying out recording and readout with laser beams, which includes at least one compound of formula (I): 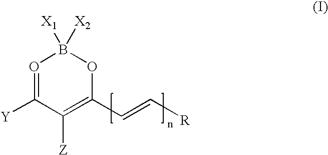
where n is selected from the group consisting of integer 0˜3; B represents boron; O represents oxygen; X₁ and X₂ are individually selected from the group consisting of oxygen and fluorine; Y is selected from the group consisting of alkoxyl, alkoxycarbonyl, phenylcyclo having substituent, phenylcyclo having non-substituent, a heterocyclic structure having boron, nitrogen, oxygen, sulfur and selenium (which is composed of Y and Z); Z is selected from the group consisting of hydrogen, alkoxyl, cyanogen radical, the heterocyclic structure having boron, nitrogen, oxygen, sulfur and selenium (which is composed of Y and Z); R is selected from the group consisting of alkoxyl, amino, phenylcyclo having substituent, phenylcyclo having non-substituent, ferrocenyl, a heterocyclic structure having boron, nitrogen, oxygen, sulfur and selenium.

The dye composition has strong absorbance (ε≧10⁴ cm²/mole) for the ultraviolet light and the visible light region, it is therefore that the dye composition is suitable for forming an information recording layer of the optical recording medium. Further, the dye composition is also suitable for FMD-ROM/FMD-R because of the high fluorescent quantum efficiency.

### BACKGROUND OF THE INVENTION

1. Field of the Invention

The present invention generally relates to a dye composition suitable for forming an optical recording medium, and more particularly to a dye composition which has strong absorbance in the visible light region from 300 nm to 800 nm, light and thermal stabilities and high fluorescent quantum efficiency, and is suitable for forming an information recording layer of an optical recording medium.

2. Description of the Prior Art

With the progress of generation, a great quantity of information is in circulation, but the traditional magnetic disc recording medium cannot satisfy the trend. Therefore, a recording medium with high density in storage, miniaturization and lower cost is needed, and the optical recording medium is developed. As the development of the DVD research, the data capacity of the DVD with single-layer and single-side is 4.7 GB at present. Recently, the functional pigments with the combination of organic synthesis chemistry and photochemistry have been used in several industries, such as non-linear optical elements, optical disc recording medium, photoresist, thermal/light/electric sensors and detectors, energy transfer and storage, medical treatment and organism.

In the so-called “Write Once Read Many” (WORM) recording media, information is recorded in the form of a pit “burned in” by an incident laser beam, thus the information is capable of being read only. In the early research, low-melting metals are used to be the materials of the information recording layer (for instance, Bi, Re, Te and the alloy of them, or thin films with semimetal materials, Pb—Te—Se, TeOx, Te—O—Pd. In 1997, Taiyo Yuden Co. presents a WORM by using organic dyes as the material of the information recording layer; it is therefore that the usage range of the optical recording medium is changed. WORM technology utilizes a heating process of a small area by a laser beam, the dye materials in the heating zone achieve a transient temperature and then being eliminated from the substrate, thus pits are formed. Further, data storage method is to change the reflectivity of the zone; although the data recorded cannot be modified, however, the advantage of that is low cost and long-time preserve.

In addition, the organic materials of WORM optical recording medium are various, for instance, azo dye, anthraaquinone dye, cyanine dye, indolizium and phthalocyanine dye. In comparison with the metal materials and the semimetal thin-films, the features of organic dyes include being instable in atmosphere, easy to oxidize, low melting and high sensitivity for recording. However, organic dyes are easy to color-fade when being exposed to the sun, the wavelength is narrower of light absorption; thus the particular dye is only suitable for the particular wavelength range.

In 1981, Law et al. applied 3,3′-diethyl-12-acetyl-thiotetracyanine perchlorate, a kind of cyanine dye, in the fabrication of the optical disc first (see K. Y. Law, P. S. Vincett, and G. E. Johnson, Applied Physics Letters, Vol. 39, pp. 718˜720 (1981)). These kinds of dyes were chosen for the reason that they match the near IR laser pickup head. Its manufacturing method is mixing a cyanine dye with PVAc, and then coating the mixture on the substrate by spin coating to form an optical disc. With the success in applying the cyanine dye in optical memory material, different kinds of dyes are developed to use as the optical memory material, such as disclosing in JP 07254167, 09193545, 09194545, 09226250, 09274732, 10044066, 11310728 and so on. The organic dyes are used as storage material because they can be coated on the substrate by simple spin coating. The manufacturing time is short and the cost is reduced as compared with the vacuum sputtering coating. Hence, the dissolubility in organic solvent and the stability of the organic dyes are important factors.

To the optical recording medium, there are some principles and methods of raising the recording capacity at present, one of the more important among them and the process technology successfully researched is to decrease the wavelength of laser rays for read/write. For instance, the laser rays are changed from infrared rays to red rays, even to blue rays. It is an alternative method that raising the numerical aperture (i.e. NA) of lens; that is, it leads to the development of DVD-R and HD-DVDR. In the future, the data capacity of the disc can be increased up to 100 GB by using the super-resolution near field structure (i.e. Super-RENS) and the multi-layers three-dimensional disc.

The key point of raising the data capacity efficaciously is the organic dyes used for the information recording layer, no matter which process technology is used for the optical recording medium. Since organic dyes have different absorbance and reflectivity for a wavelength band of laser ray and thus they have the capability of read and write of the signals. In order to increase the data capacity of an optical disc, one of the methods is to decrease the wavelength of laser rays for read/write, thus the organic dyes used for the information recording layer are changed too. Therefore, to research and develop a dye composition having better optical properties and photoelectric properties is an important purpose of the HD-DVDR research. Since the laser wavelength used for the high density optical disc (for instance, the wavelength of the laser ray used for the DVD-R is 650 nm) is different with the laser wavelength used for the CD-R disc (which is 780 nm), thus the organic dyes cannot be used mutually. Accordingly, redesign and research a dye composition for the information recording layer of high density optical disc is a key point of research issues.

CD-R disc utilizes recording video and information through a CD burner for users, to the structure of a CD-R disc; it utilizes a recording layer of organic dye positioned between a substrate and a reflective layer. Further, the organic dye is a key point of CD-R research; however, the demand of CD-R becomes alleviative for these days. The laser wavelength used for WORM DVD-R disc (with 4.7 GB data capacity) is 650 nm, while the laser wavelength used for the CD-R disc is 780 nm; thus the organic dyes cannot be used mutually. Accordingly, redesign and research a dye composition for the information recording layer of high density optical disc is needed. The reason that organic dyes of the information recording layer are capable of read/write of signals is the photoelectric properties of strong absorbance, high reflectivity and high sensitivity for some laser wavelengths. The photoelectric properties are determined by functional groups and chromophor of the molecular structures of organic dyes; that is, the molecular structures of organic dyes influence the photoelectric properties of the optical disc very much.

The DVD specifications for the Blue-ray disc are established and announced by Matsushita, Sony, Pioneer, Sharp, Philips, Thomson, LG and Samsung on March, 2002. The DVD specifications include the followings, wavelength is 405 nm, NA is 0.85, disc diameter is 12 cm, disc thickness is 1.2 mm and data capacity is 23.3/25/27 GB. Further, the Blue-ray disc can be used to storage 2-hours high resolution video images or 13-hours conventional video images; on the other hand, Industrial Technology Research Institute (TW) also presents the specifications of the Blue-ray disc on November, 2002. A blue-violet laser beam (the wavelength of that is 405 nm) is used for the light source of the Blue-ray disc, thus it increases the data capacity of the disc very much. In theory, the data capacity of the Blue-ray disc can reach to 50 GB/side; further, if the super-resolution near field structure (i.e. Super-RENS) is added for breaking through the diffraction limit of a conventional disc. Therefore, the pit length can be reduced to be 60 nm and the data capacity of the Blue-ray disc can be raised to be 200 GB/side, it highlights for the optical disc research.

At present, three-dimensional technology is developed and the multilayer disc is used to increase the data capacity. In 1989, D. A. Pathenopoulos and R. M. Rentzepis present a paper that the fluorescent intensities are different when organic fluorescent materials are under different exciting by laser rays (see Science, Vol. 245, No. 843, 1989); thus the fluorescent materials can be used for an optical recording medium. In addition, they also solve the problem of the destructive interference of signal in the multilayer disc. In the following, Russell further presents a fluorescent multilayer disc (i.e. FMD) and the Recording/reproducing system (for instance, U.S. patents, U.S. Pat. No. 4,090,031 and U.S. Pat. No. 5,278,816).

### SUMMARY OF THE INVENTION

Accordingly, one of the purposes of the present invention is to provide a dye composition for an optical recording medium. The dye composition is presented for the optical recording medium at the first time; further, the absorbance range of the dye composition is easy to be adjusted (from 300 nm to 800 nm), the chemical structure of the dye composition is easy to be synthesized. Furthermore, the dye composition has a good solvability for the solvents, for instance, 2,2,3,3-tetrafluoropropanol, and it is favorable to the spin coating process. Besides, the dye composition has high sensitivity to the laser wavelength 405 nm and 657 nm (ε≧10⁴ cm²/mole) and thus it is suitable for the high-speed optical recording medium. Further, because of the high fluorescent quantum efficiency the dye composition is suitable for producing the fluorescent multilayer disc (i.e. FMD).

### BRIEF DESCRIPTION OF THE DRAWINGS

The present invention can be best understood through the following description and accompanying drawings, wherein:

FIG. 1 depicts the absorption spectrum of the compound II-1 within a methanol solution;

FIG. 2 depicts the thermal properties analysis (DTA) of the compound II-1;

FIG. 3 depicts the spectrum diagram of the reflectivity when the compound II-1 is used for a fabricating process of a DVD-R;

FIG. 4 depicts the absorption spectrum of a thin-film including the compound II-22;

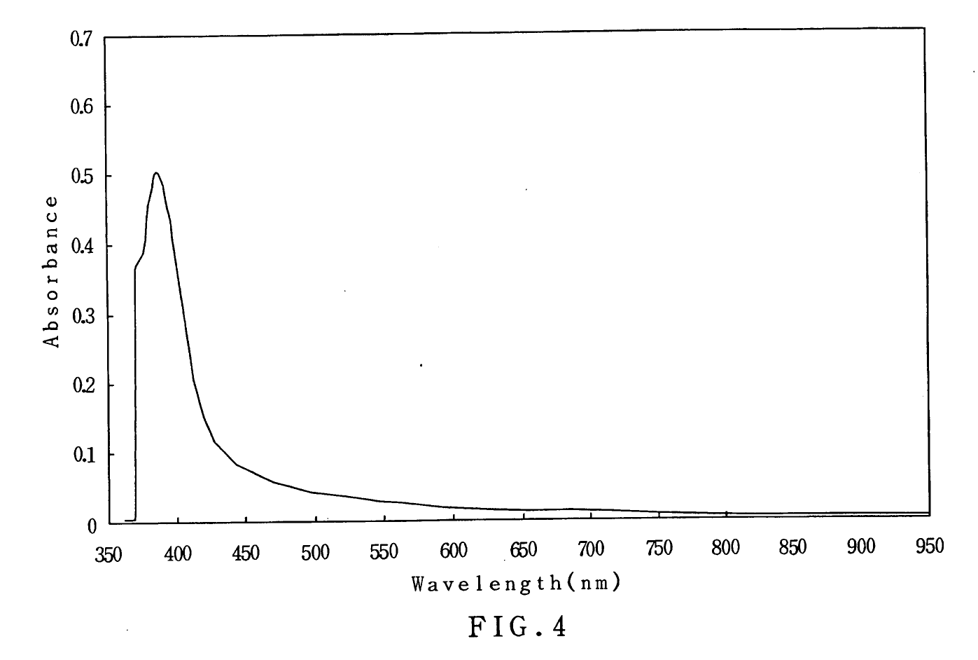

FIG. 5 depicts the bright spots of FMD-ROM disc signals; and

FIG. 6 depicts the fluorescent intensity analysis of the bright spots in FIG. 5.

### DESCRIPTION OF THE PREFERRED EMBODIMENT

Some appropriate and preferred embodiments of the present invention will now be described in the following. It should be noted, however, that the embodiment is merely an example and can be variously modified without departing from the range of the present invention.

In one embodiment of the present invention, a dye composition suitable for forming an information recording layer is provided, which includes at least one compound of formula (I): 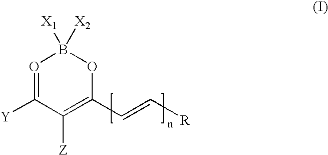
where n is selected from the group consisting of integer 0˜3; B represents boron; O represents oxygen; X₁ and X₂ are individually selected from the group consisting of oxygen and fluorine; Y is selected from the group consisting of alkoxyl, alkoxycarbonyl, aromatic structure having substituent, aromatic structure having non-substituent, a heterocyclic structure having boron, nitrogen, oxygen, sulfur and selenium (which is composed of Y and Z); is selected from the group consisting of hydrogen, alkoxyl, cyanogen, the heterocyclic structure having boron, nitrogen, oxygen, sulfur and selenium (which is composed of Y and Z); R is selected from the group consisting of alkoxyl, amino, aromatic structure having substituent, aromatic structure having non-substituent, ferrocenyl, a heterocyclic structure having boron, nitrogen, oxygen, sulfur and selenium.

In order to achieve the purposes of the present invention, some embodiments will be depicted in the following for illustrating the characteristics of the present invention; however, the embodiments doesn't limit to the characteristics of the present invention.

### EXAMPLE 1

### The Method of Producing a Dye Composition

Taking 0.01 mole mid-TMBI-E (the chemical structure of that is shown as follows) and 0.01 mole 1-(1-(difluoroboryl) oxy-3,4-dihydro-naphthalen-2-yl)-ethanol inner complex, and adding them to ethanol solution including 0.015 mole sodium acetate and being heated to a reflux temperature for 3˜4 hours through a chemical reaction. After the chemical reaction, a brown solid (II-1) is generated through a filtering step and an oven-drying step, and the yield is 70%. The reaction process is as shown in the following reaction formula:

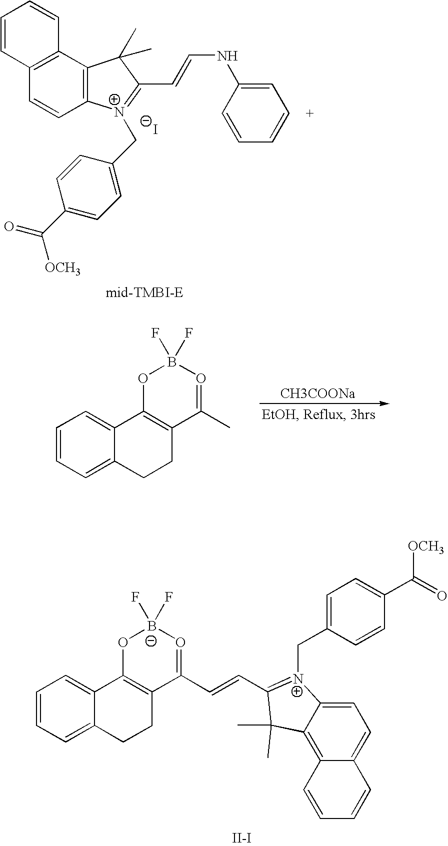

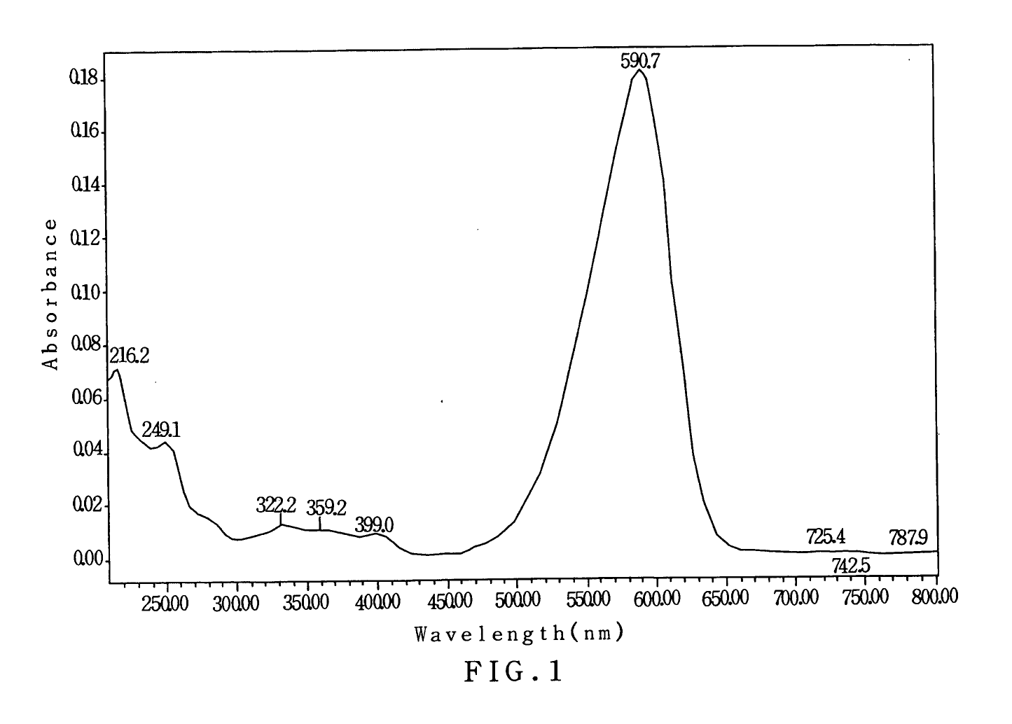

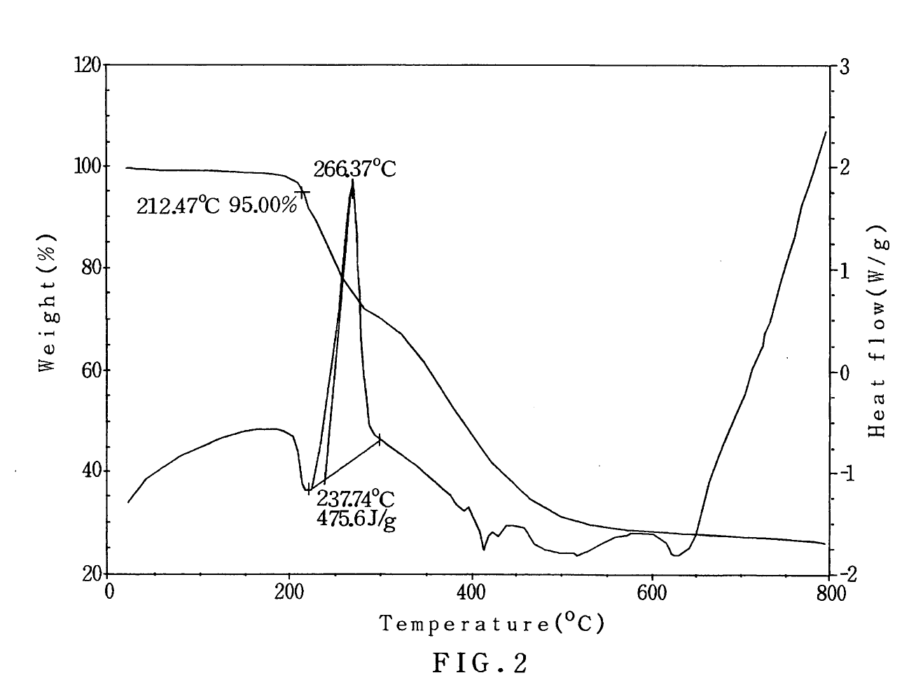

After a physical property analysis, the absorption spectrum of the compound II-1 within a solution is obtained, as shown in FIG. 1, the maximum absorption position of the compound II-1 within a methanol solution is 590 nm. Besides, the thermal property of the dye composition is as shown in FIG. 2. It should be appreciated that, the chemical structure of the dye composition is emphasized; however, the producing method of the dye composition is described by an enumeration method and will not be described the details of that.

### Example 2

### The Maximum Absorption Wavelength of the Dye Compositions Under a Liquid State

In the following, the chemical structures of the dye compositions that are produced (the serial numbers of the dye compositions are respectively II-1˜II-24), and the maximum absorption wavelength of the dye compositions within a methanol solution are respectively shown in Table.1.

TABLE 1
The chemical structures of the dye compositions and the
maximum absorption positions of the dye compositions under a liquid state

| Serial | | Maximum absorption |
|---|---|---|
| numbers of | | position of the dye |
| the dye | | compositions under a |
| compositions | Chemical structure | liquid state (MeOH) |
| II-1 | 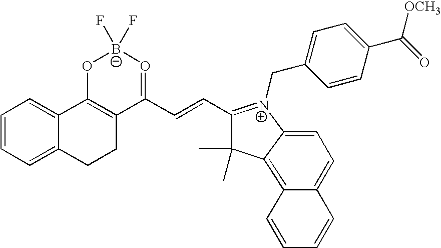 | 590 nm |
| II-2 | 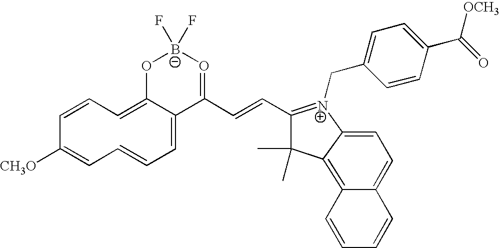 | 592 nm |
| II-3 | 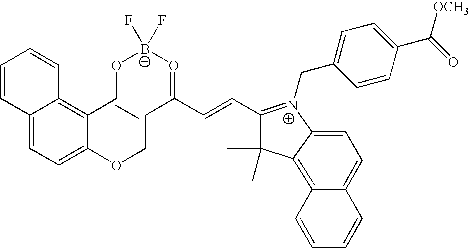 | 612 nm |
| II-4 | 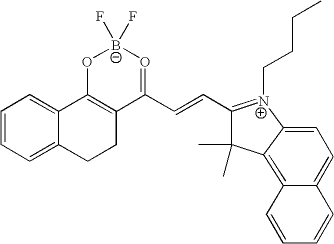 | 587 nm |
| II-5 | 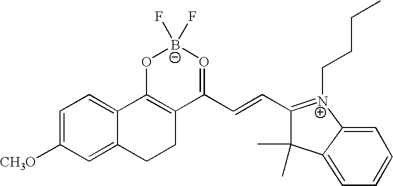 | 594 nm |
| II-6 | 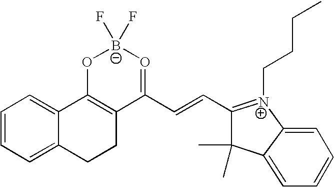 | 577 nm |
| II-7 | 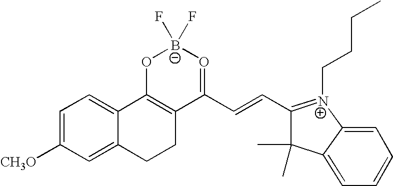 | 581 nm |
| II-8 | 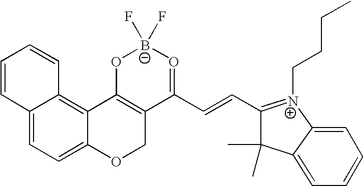 | 601 nm |
| II-9 | 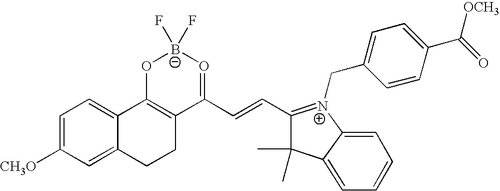 | 571 nm |
| II-10 | 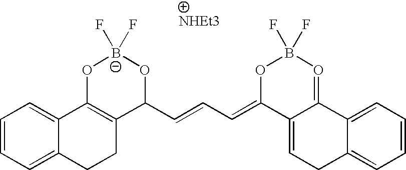 | 615 nm |
| II-11 | 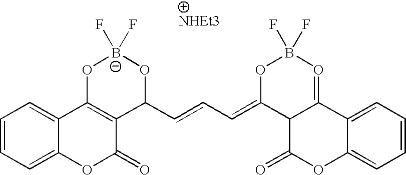 | 582 nm |
| II-12 | 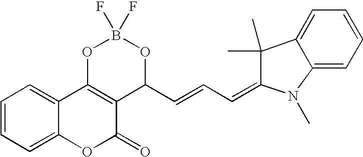 | 569 nm |
| II-13 | 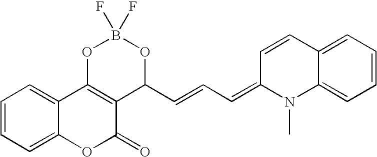 | 596 nm |
| II-14 | 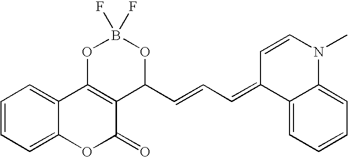 | 650 nm |
| II-15 | 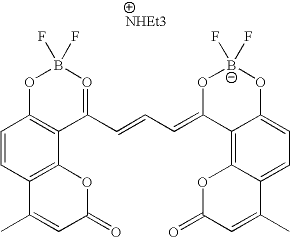 | 567 nm |
| II-16 | 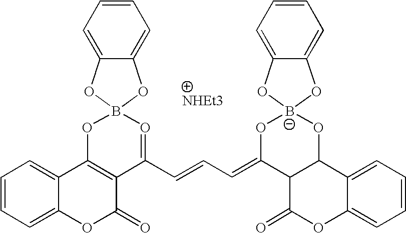 | 596 nm |
| II-17 | 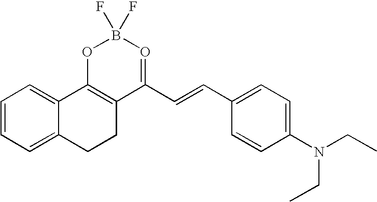 | 560 nm |
| II-18 | 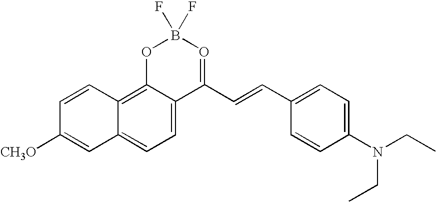 | 555 nm |
| II-19 | 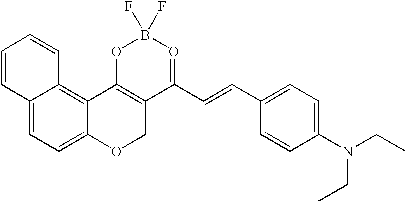 | 578 nm |
| II-20 | 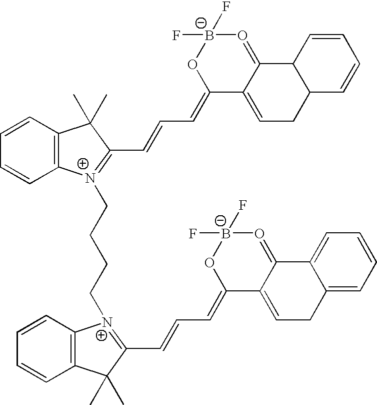 | 579 nm |
| II-21 | 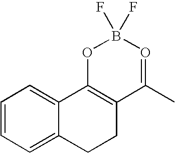 | 340 nm |
| II-22 | 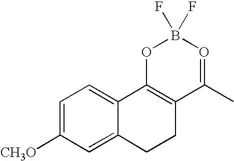 | 356 nm |
| II-23 | 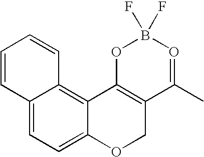 | 412 nm |
| II-24 | 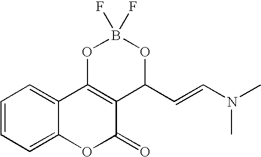 | 392 nm |

### Example 3

### The Production of a DVD-R and Testing of the Electro-Properties

Example 3 depicts the compound II-1 used in a fabricating process of a high density recordable disc (4.7 GB DVD-R). Taking a 1.5 g dye composition with a chemical formula as compound II-1 to be dissolved in 2,2,3,3-tetrafluoropropanol to form 100 g solution.

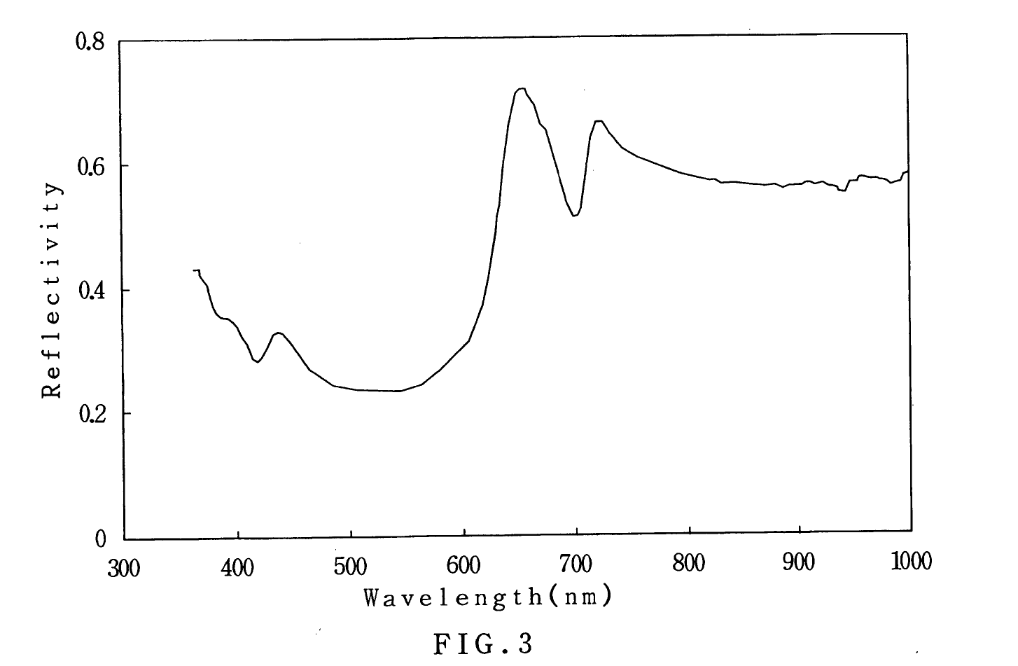

And then, coating a transparent PC substrate including lands and grooves (the thickness of the substrate is 0.6 mm) with the solution that are produced above-mentioned through a spin coater; in addition, by using a coating process (for instance, a spin coating process, a whirl coating process) and an oven-drying process to form a dye recording layer coated on the substrate (the thickness of that is about 70˜150 nm). Next, sputtering a reflective layer having the material of Au or Ag (the thickness of that is about 50˜300 nm) onto the dye recording layer. Finally, boding the substrate including the reflective layer and the dye recording layer to another PC substrate (the thickness of that is 0.6 mm), thus a high density recordable disc (DVD-R) with the 120 mm thickness is generated. Further, the bonding method can be a spin coating method, a screen printing method and a thermal bonding method. FIG. 3 depicts a spectrum diagram of the reflectivity and the wavelength, where the reflectivity of the disc is greater than 45% when the wavelength of that is 635 nm or 650 nm.

In the following, a write test and a read test of the DVD-R produced above-mentioned are performed by using the PULSTEC DDU-1000 tester. Further, the conditions of the write test are as follows, the constant linear velocity (CLV) is 3.5 m/s, the wavelength is 657 nm, the numerical aperture (NA) is 0.6 and the write power is about 7˜14 mW; on the other hand, the conditions of reading test are as follows, CLV is 3.5 m/s, wavelength is 658 nm, NA is 0.6 and the reading power is about 0.5˜1.5 mW.

TABLE 2
3T CNR of the compound II-1 and the write power of a laser
beam

| | Write power (mW) | | | | | | | |
|---|---|---|---|---|---|---|---|---|
| | 7 | 8 | 9 | 10 | 11 | 12 | 13 | 14 |
| 3T CNR (dB) | 45.3 | 51.3 | 54.3 | 54.8 | 55.2 | 55.2 | 55.1 | 54.8 |

As is described above, the carrier noise ratio (CNR) is about 55.2 dB under a tester with 10-mW write power, the details of that are shown in Table.2.

### Example 4

### The Production of a HD-DVDR

Example 4 depicts the compound II-22 used in a fabricating process of a high density recordable disc (HD-DVDR). Taking a 1.5 g dye composition with a chemical formula as compound II-22 to be dissolved in 2,2,3,3-tetrafluoropropanol to form 10 g solution.

And then, coating a transparent PC substrate including lands and grooves (the thickness of the substrate is 0.6 mm) with the solution that are produced above-mentioned through a spin coater; in addition, by using a coating process (for instance, a spin coating process, a whirl coating process) and an oven-drying process to form a dye recording layer coated on the substrate (the thickness of that is about 70˜200 nm). Next, sputtering a reflective layer having the material of Au or Ag (the thickness of that is about 50˜300 nm) onto the dye recording layer. Finally, boding the substrate including the reflective layer and the dye recording layer to another PC substrate (the thickness of that is 0.6 mm), thus a high density recordable disc (HD-DVDR) with the 120 mm thickness is generated. Further, the bonding method can be a spin coating method, a screen printing method and a thermal bonding method.

### Example 5

### The Production of a FMD-ROM Disc

Example 5 depicts the compound II-23 used in a fabricating process of a FMD-ROM disc. By using the compound II-23 to produce a fluorescent thin-film and measure the properties of that. First, the compound II-23 is dissolved in a polymer solution for forming a dye solution (the volumetric molar concentration of that is 10-3 M), the polymer solution has propylene glycol monomethyl ether (PM) including 5.0 Wt % (i.e. weight percentage) polyvinyl butyral (PVB). Then, by using a coating process (for instance, a spin coating process, a whirl coating process) to coat the read-only type substrate (DVD-ROM substrate) with the dye solution for forming a film, and an oven-drying process is performed for forming a fluorescent recording thin-film.

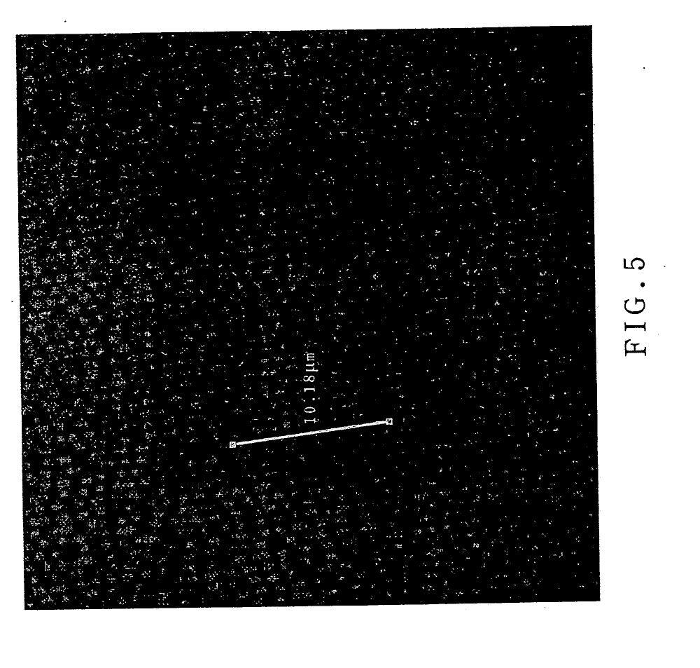

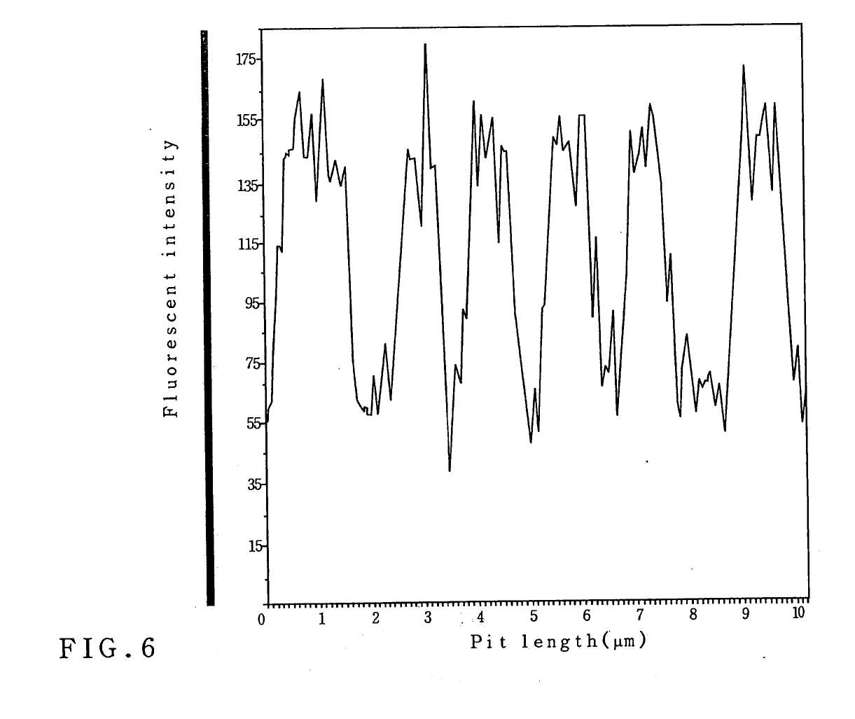

The bright-spots diagram of green light including a bright/dark-crossed arrangement can be obtained through a process of being excited by a blue light laser (the wavelength of that is 405 nm), which is as shown in FIG. 5. The difference between the brightness and the darkness is caused by the strength of the fluorescent intensity, thus the information encoding of 0 and 1 can be acquired by the bright spots and the dark spots. FIG. 6 depicts a fluorescent intensity diagram that passed by the white line segment in FIG. 5. In comparison with FIG. 5, it is distinct that the bright-spot zone has stronger fluorescent intensity and the dark-spot zone has weaker fluorescent intensity, and the contrast value of the fluorescent intensity is about 62.5%. It should be emphasized that the contrast value of the fluorescent intensity is defined as (the fluorescent intensity of the bright-spots—the fluorescent intensity of the dark-spots)÷the fluorescent intensity of the bright-spots.

Accordingly, the dye compositions of the present invention have strong absorbance, high sensitivity and high power record for the ultraviolet light region and the visible light region (i.e. λ=300 nm˜800 nm), and they have high recording sensitivity and S/N ratio (i.e. signal/noise ratio), thus the dye compositions are suitable for forming an information recording layer. Besides, the dye compositions of the present invention can be dissolved in the organic solvents, such as alcohols, ketones, esters, ethers, halogen compounds and amides, thus a coating process can be used to coat the substrate with the dye compositions (for instance, a spray-up method, a wheeling coating, an impregnation method and a spin coating. Furthermore, the dye compositions of the present invention can be used not only in the information recording layer, but also in the photoresist for integrated circuits, stock dyeing for the textile industry, manifolding and print.

While this invention has been described with reference to illustrative embodiments, this description does not intend or construe in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A dye composition suitable for forming an information recording layer of an optical recording medium, the dye composition comprising at least one compound of formula (I): 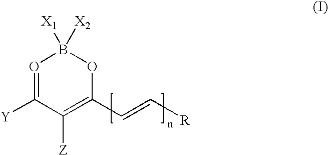
wherein, n is selected from the group consisting of integer 0˜3;
X₁ and X₂ are individually selected from the group consisting of oxygen and fluorine;
Y is selected from the group consisting of alkoxyl, alkoxycarbonyl, aromatic structure having substituent, aromatic structure having non-substituent, a nitrogenous heterocyclic structure;
Z is selected from the group consisting of hydrogen, alkoxyl, cyanogen radical, said nitrogenous heterocyclic structure;
R is selected from the group consisting of alkoxyl, amino, aromatic structure having substituent, aromatic structure having non-substituent, ferrocenyl, heterocyclic structure having boron, nitrogen, oxygen, sulfur and selenium.

2. The dye composition according to claim 1, wherein said nitrogenous heterocyclic structure is a heterocyclic structure composed of Y and Z which has boron, nitrogen, oxygen, sulfur and selenium.

3. A high-density optical recording medium, comprising:
a first substrate having a plurality of lands and a plurality of grooves;
a recording layer disposed on said first substrate, wherein said recording layer comprises a dye composition having at least one compound of formula (I): 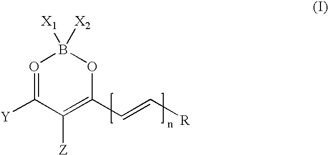
wherein, n is selected from the group consisting of integer 0˜3; X₁ and X₂ are individually selected from the group consisting of oxygen and fluorine; Y is selected from the group consisting of alkoxyl, alkoxycarbonyl, aromatic structure having substituent, aromatic structure having non-substituent, a nitrogenous heterocyclic structure; Z is selected from the group consisting of hydrogen, alkoxyl, cyanogen radical, said nitrogenous heterocyclic structure; R is selected from the group consisting of alkoxyl, amino, aromatic structure having substituent, aromatic structure having non-substituent, ferrocenyl, heterocyclic structure having boron, nitrogen, oxygen, sulfur and selenium;
a reflective layer disposed on said recording layer;
a protective layer disposed on said reflective layer; and
a second substrate in proximity of said protective layer.

4. The high-density optical recording medium according to claim 3, wherein said nitrogenous heterocyclic structure is a heterocyclic structure composed of Y and Z which has boron, nitrogen, oxygen, sulfur and selenium.

5. The high-density optical recording medium according to claim 3, wherein the material of said reflective layer is selected from the group consisting of Au, Ag, Al, Si, Cu, Ag—Ti alloy (silver tatanium alloy), Ag—Cr alloy (silver chromium alloy) and Ag—Cu alloy (silver copper alloy).

6. The high-density optical recording medium according to claim 3, wherein the thickness range of said reflective layer is from 50 nm to 300 nm.

7. A fluorescent optical recording medium, comprising:
a substrate;
a fluorescent recording layer in proximity of said substrate, wherein said fluorescent recording layer is formed by doping an appropriate high polymeric material with a dye composition, and said fluorescent recording layer is excited by a laser beam and then a fluorescence is emitted; and
said dye composition having at least one compound of formula (I): 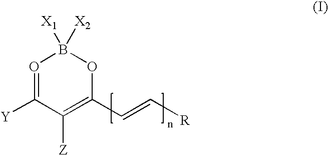
wherein, n is selected from the group consisting of integer 0˜3; X₁ and X₂ are individually selected from the group consisting of oxygen and fluorine; Y is selected from the group consisting of alkoxyl, alkoxycarbonyl, aromatic structure having substituent, aromatic structure having non-substituent, a nitrogenous heterocyclic structure; Z is selected from the group consisting of hydrogen, alkoxyl, cyanogen radical, said nitrogenous heterocyclic structure; R is selected from the group consisting of alkoxyl, amino, aromatic structure having substituent, aromatic structure having non-substituent, ferrocenyl, heterocyclic structure having boron, nitrogen, oxygen, sulfur and selenium.

8. The fluorescent optical recording medium according to claim 7, wherein said nitrogenous heterocyclic structure is a heterocyclic structure composed of Y and Z which has boron, nitrogen, oxygen, sulfur and selenium.

9. The fluorescent optical recording medium according to claim 7, wherein said laser beam is a blue-violet laser when said laser beam is excited by a single-photon excitation method, and the wavelength range of said laser beam is from 400 nm to 480 nm.

10. The fluorescent optical recording medium according to claim 7, wherein said laser beam is a red laser when said laser beam is excited by a two-photon excitation method, and the wavelength range of said laser beam is from 780 nm to 830 nm.

11. The fluorescent optical recording medium according to claim 7, wherein said high polymeric material is selected from the group consisting of polyester (PET), polycarbonate (PC), polymethylmethacrylate (PMMA), chitin, acetate fiber, polyethylene (PE) resin and metallocene catalyzed cyclo olefin copolymer (MCOC).
